(19) United States
(12) Patent Application Publication
(10) Pub. No.: US 2026/0303628 A1
(43) Pub. Date: Oct. 1, 2026

(54) DYNAMIC SENSITIVITY SCORING FRAMEWORK FOR PROACTIVE SECURITY IN CLOUD INFRASTRUCTURE

(71) Applicant: Microsoft Technology Licensing, LLC, Redmond, WA (US)

(72) Inventors: Abhijeet Surendra HATEKAR, Kirkland, WA (US); Harish SANGIREDDY, Fall City, WA (US); Wesley Scott DRONE, Maryville, IL (US)

(21) Appl. No.: 19/094,552

(22) Filed: Mar. 28, 2025

(51) Int. Cl. H04L 9/40

(52) U.S. Cl. CPC H04L 63/1425

(57) ABSTRACT

The present disclosure relates to systems and methods for identifying cybersecurity risks. The systems and methods automate monitoring and anomaly detection. The systems and methods use a security graph enriched with metadata in automatically identifying sensitive resources. The systems and methods monitor the identified sensitive resources for anomalies.

### BACKGROUND

In modern cloud environments, managing and securing identities and activities is a critical challenge. Cloud environments typically include millions of identities, including users, service principals, and applications. The identification of sensitive resources, such as security groups, key vaults, and service principals often relies on manual tagging, static configurations, or predefined rules. Sensitive resources are often indirectly linked to high-risk activities or configurations making it difficult to detect their criticality without dynamic propagation of sensitivity.

### BRIEF SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Some implementations relate to a method. The method includes traversing, using a machine learning model, a security graph with nodes representing entities in a cloud environment and edges representing relationships between the entities. The method includes identifying, using the machine learning model, an entity identified as a sensitive asset using metadata in the security graph. The method includes adding the entity to a list of sensitive assets. The method includes discovering, by the machine learning model, dependent entities to the entity using the edges in the security graph. The method includes adding the dependent entities to the list of sensitive assets. The method includes monitoring, by the machine learning model, access patterns of the entity and the dependent entities in the list of sensitive assets. The method includes identifying, by the machine learning model, an anomaly in the access patterns. The method includes sending an alert in response to identifying the anomaly.

Some implementations relate to a device. The device includes a memory to store data and instructions; and a processor operable to communicate with the memory, wherein the processor is operable to: identify, using a machine learning model, an entity in a cloud environment identified as a sensitive asset using metadata in a security graph with nodes representing entities in a cloud environment and edges representing relationships between the entities; add the entity to a list of sensitive assets; discover, using the machine learning model, dependent entities to the entity using the security graph; add the dependent entities to the list of sensitive assets; monitor, using the machine learning model, the entity and the dependent entities in the list of sensitive assets; identify, using the machine learning model, an anomaly in the list of sensitive assets in response to the monitoring; and send an alert with the anomaly in response to identifying the anomaly.

Some implementations relate to a computer-readable storage medium including instructions that, when executed by a processor, cause the processor to: traverse, using a machine learning model, a security graph with nodes representing entities in a cloud environment and edges representing relationships between the entities; identify, using the machine learning model, an entity identified as a sensitive asset using metadata in the security graph; add the entity to a list of sensitive assets; discover, by the machine learning model, dependent entities to the entity using the edges in the security graph; add the dependent entities to the list of sensitive assets; monitor, by the machine learning model, access patterns of the entity and the dependent entities in the list of sensitive assets; identify, by the machine learning model, an anomaly in the access patterns; send an alert in response to identifying the anomaly; and perform an action preventing a cybersecurity risk in the cloud environment in response to the alert.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for identifying cybersecurity risks in accordance with implementations of the present disclosure.

FIG. 2 illustrates an example method for discovering sensitive assets in accordance with implementations of the present disclosure.

FIG. 3 illustrates an example security graph in accordance with implementations of the present disclosure.

FIG. 4 illustrates a method for identifying cybersecurity risks in accordance with implementations of the present disclosure.

FIG. 5 illustrates components that may be included within a computer system in accordance with implementations of the present disclosure.

### DETAILED DESCRIPTION

This disclosure generally relates to identifying cybersecurity risks. In the complex world of cloud environments, ensuring the security of identities and access is a critical challenge. With millions of service principals, applications, and sensitive resources spanning multiple tenants and subscriptions, traditional logging and monitoring techniques often fail to provide actionable insights at scale. The identification of sensitive resources, such as security groups, key vaults, and service principals often relies on manual tagging, static configurations, or predefined rules. Sensitive resources are often indirectly linked to high-risk activities or configurations, making it difficult to detect their criticality without dynamic propagation of sensitivity.

Existing solutions manually label critical assets which is time consuming and prone to errors. Existing solutions are static in nature using predefined rules identifying sensitive resources based on specific configurations or attributes, lacking the flexibility to capture complex relationships or dynamic behaviors. Existing solutions lack contextual awareness and are unable to analyze indirect relationships or transitive risks in complex cloud environments and cannot detect unknown patterns or indirect sensitivities. Existing solutions are unable to adapt to dynamically evolving configurations, permissions, and relationships. Existing solutions focus on reactive detection responding to incidents rather than proactively identifying and addressing potential risks. Existing solutions rely heavily on human tagging and manual policy management, which are error-prone, static, and insufficient in the face of evolving threats.

An error can have significant security consequences, e.g., if a threat goes undetected because of human error. One example security consequence is misconfigured conditional access policies. Another example security consequence is a multi-factor authentication (MFA) bypass via exception groups. Another example security consequence is privilege escalation through excessive permissions. Another example security consequence is exploitation of unmonitored, high-privilege service principals or applications. Reliably automating the discovery and prioritization of sensitive assets therefore yields a consequent improvement in system/network security.

The present disclosure provides systems and methods for automatically identifying cybersecurity risks. A cybersecurity risk is a potential threat for exposure or loss resulting from a cyberattack or data breach on a digital system or network. The systems and methods enable automated proactive monitoring and anomaly detection in a cloud environment. The systems and methods use a dynamic sensitivity scoring framework that identifies, scores, and monitors critical or sensitive assets in cloud infrastructures. A critical asset is an asset that impacts operations within a cloud environment (e.g., a resource that is mission critical to cloud operations). The systems and methods leverage a graph-based model enriched with contextual relationships, permissions, and historical threat intelligence. The systems and methods use artificial intelligence (AI) powered algorithms and dynamic propagation techniques in identifying and scoring sensitive resources extending beyond direct relationships. Sensitive resources focus on data sensitivity and exposure. Sensitive resources are any resource that has, holds, transmits, or protects valuable information. Sensitive resources are the important parts of a cloud setup that hold valuable information or control key systems. Sensitive resources include information that needs protection from hackers, accidents, or other cybersecurity risks. In a context of a graph (for example, a network of systems, a social network, or any graph representing interconnected resources), sensitive resources are those nodes (or in some cases edges) deemed critical, valuable, or high-risk. Sensitive resources are the assets that, if compromised or removed, significant disruption or damage may result. Examples of sensitive resources include security groups, applications, service principals, databases, and key vaults. The systems and methods combine graph-based analysis, artificial intelligence, and real-time monitoring proactively identifying and scoring sensitive resources in a cloud infrastructure.

The present disclosure includes a number of practical applications that provide benefits and/or solve problems associated with identifying cybersecurity risks. Examples of these applications and benefits are discussed in further detail below. One example benefit is enhanced security without manual tagging or static configurations. The systems and methods identify transitive dependencies and indirect risks, detecting sensitive entities automatically providing early identification of issues, such as misconfigured policies or privilege escalations. The systems and methods focus on strategic detection of critical assets and evolving threats, reducing the need for manual tagging and redundant scans.

Another example benefit is scalable proactive security. Using graph analytics with machine learning for automated sensitivity detection and scoring, the systems and methods can handle large, complex cloud environments with millions of entities and relationships, continuously adapting to changes in infrastructure or attack patterns.

Another example benefit is context aware holistic risk awareness. The systems and methods combine permissions, relationships, and historical threat intelligence and behavioral insights ensuring accurate sensitivity scoring and minimizing false positives by focusing on high-impact resources providing a comprehensive view of infrastructure vulnerabilities.

In some implementations, the systems and methods construct a security graph with nodes representing entities (e.g., security groups, service principals, key vaults, and policies) and edges representing relationships between the entities (e.g., permissions, access paths, and dependencies). An entity is an object or concept within a system. In some implementations, the entities are relevant to security investigations. Relationships define how two entities relate to each other. Relationships between entities specify how entities are associated with each other or linked together. In some implementations, the security graph is enriched with metadata, including historical threat intelligence, activity logs, and configurations. In some implementations, the systems and methods include dynamic sensitivity propagation. The systems and methods use the security graph in propagating sensitivity scores beyond direct relationships accounting for transitive dependencies and indirect risks. For example, a service principal with tenant-wide permissions propagates sensitivity to all associated key vaults and downstream resources.

In some implementations, the systems and methods use AI-powered sensitivity scores. The systems and methods use unsupervised machine learning models in detecting anomalies and clustering similar entities based on configurations, behaviors, and relationships. A scoring formula integrating permissions, activity patterns, historical intelligence, and anomalies is used by the machine learning models in assigning an entity a sensitivity score dynamically. The sensitivity scores reflect a criticality, risk exposure, and anomaly indicators of an entity. A sensitivity score is a number or a rating that tells how critical or risky a resource is if the resource is exposed, misused, or compromised.

In some implementations, the systems and methods leverage generative AI models. Examples of generative AI models include Generative Pre-trained Transformer (GPT) machine learning models (e.g., GPT-3 or GPT-4), LlaMA, and GEMINI. Examples of generative AI models also include text-to-image models, such as DALL-E. Generative AI models generate content, such as text, images, video, audio, or other data in response to a question or prompt. Another example of a generative AI model includes multi-modal models. In some implementations, the question or prompt is multi-modal input, and the generative AI model processes the multi-modal input to generate content. For example, the generative AI model receives non-text input and generates an output of text. Another example includes the generative AI model receives text input and generates a non-text output. Generative AI models learn the patterns and structure of the input training data and generate new data that has similar characteristics to the input data in response to prompts based on the instructions in the prompts.

In some implementations, the systems and methods perform context-aware prioritization. The systems and methods prioritize resources based on criticality of the resources, behavioral deviations, and historical threat patterns. In some implementations, the systems and methods perform continuous monitoring and feedback providing real-time sensitivity scores updates based on configuration changes, activity patterns, or new threat intelligence.

The systems and methods provide a proactive, AI-driven approach, providing scalable coverage reducing reliance on manual tagging. The systems and methods identify, prioritize, and monitor sensitive assets in cloud infrastructures. Through continuous monitoring and AI-powered anomaly detection, the systems and methods adapt to evolving configurations and behaviors, delivering actionable insights enhancing security posture without relying on static tags or manual interventions.

The systems and methods provide a proactive approach in securing cloud infrastructure by dynamically discovering and prioritizing sensitive resources. By leveraging graph based relationships, AI-powered scoring, and continuous monitoring, the systems and methods enable security researchers and incident responders to stay ahead of evolving threats, ensuring robust and adaptive security across cloud environments.

One technical advantage of the systems and methods of the present disclosure is effective utilization of compute resources. The systems and methods save costs and reduce largescale processing by focusing compute resources on high-risk areas, thereby avoiding the need for blanket monitoring of all entities in the cloud infrastructure. By dynamically prioritizing sensitive assets based on criticality and contextual relationships, the systems and methods minimize unnecessary computation on benign or low-risk entities. The graph-based architecture further optimizes processing by leveraging targeted traversals and enriched metadata resulting in efficient sensitivity scoring and anomaly detection.

Another technical advantage of the systems and methods of the present disclosure is accurate sensitivity scoring. The systems and methods minimize false positives by focusing on high-impact resources providing a comprehensive view of infrastructure vulnerabilities. Another technical advantage of the systems and methods of the present disclosure is automating the identification of anomalies.

Another technical advantage of the systems and methods of the present disclosure is real-time monitoring of cloud events supporting advanced cyber security threat hunting. The systems and methods enable real-time monitoring of cloud events and post-event analysis allowing security teams to proactively search for and mitigate potential cybersecurity threats before causing significant harm in a cloud environment. The systems and methods streamline the security investigation process reducing the time and effort required to analyze potential cybersecurity threats.

One example use of the systems and methods includes a service principal with high permissions accesses a key vault. The systems and methods flag the key vault and propagates sensitivity to secrets stored within the key vault. Anomalies in access patterns (e.g., sudden spikes in secret retrievals) trigger alerts by the systems and methods.

Another example use of the systems and methods includes a security group is excluded from multi-factor authentication (MFA) or conditional access policies. The systems and methods identify and score the group based on permissions and memberships of the security group. Frequent membership changes or external user additions raise flags by the systems and methods requiring further monitoring or analysis.

Another example use of the systems and methods includes an application granted tenant-wide or application-only permissions (e.g., directory.read.all) is flagged by the systems and methods. Resources the application interacts with, such as databases or key vaults, are marked for monitoring by the systems and methods. New interactions by the application with high-value resources are flagged for further investigation by the systems and methods.

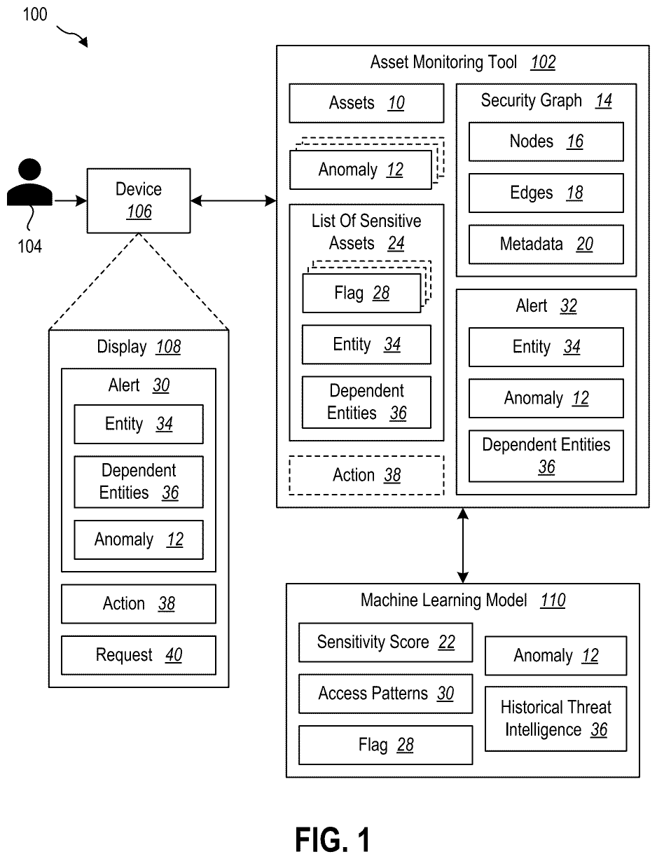

Referring now to FIG. 1, illustrated is an example environment 100 that identifies cybersecurity risks. The environment 100 includes an asset monitoring tool 102 that aids users 104 in identifying cybersecurity risks. In some implementations, the asset monitoring tool 102 aids the users 104 in identifying cybersecurity risks in a cloud environment. The asset monitoring tool 102 monitors assets 10. An asset 10 is a resource or a resource property. In some implementations, the assets 10 are resources or resource properties in a cloud environment. In some implementations, the assets 10 are resources or resource properties in a device. The asset monitoring tool 102 monitors the assets 10 identifying any anomalies 12 occurring. An anomaly 12 is any unusual activity that occurred. One example of an anomaly is an error. Another example of an anomaly is an unexpected event. For example, an anomaly is detected for an account logon success when an unsuccessful account logon is expected. Another example of an anomaly is a command line with an unusual structure (e.g., longer than expected or shorter than expected). Another example of an anomaly is a user logging in from a different location than a previously logged location (e.g., logging in from Canada when a home location is the US). Another example of an anomaly is command lines having suspicious encoded commands and reaching to external networks (e.g., internet) to download malicious payloads (e.g., executable, scripts, etc.).

In some implementations, the asset monitoring tool 102 generates a security graph 14 representing the assets 10. A security graph provides a visual representation of the assets 10 and the relationships between the assets 10. In some implementations, the assets 10 included in the security graph 14 are assets 10 to protect from cybersecurity threats. The security graph 14 includes nodes 16 and edges 18. The nodes 16 represent entities (the assets 10). In some implementations, the nodes 16 represent the assets 10 in a device. In some implementations, the nodes 16 represent the assets 10 in the cloud environment. Examples of entities include service principals, applications, databases, key vaults, security groups, and policies. The edges 18 represent relationships between the entities. Example relationships include group memberships, access permissions, resource interactions, and policy exclusions. In some implementations, the security graph 14 identifies sensitive resources (e.g., the nodes (or in some cases, edges) deemed critical, valuable, or high-risk). A critical business or mission assets in a security graph 14 are nodes 16 that represent the most important resources for an organization or a system. For instance, in a computer network, the critical business assets are the servers hosting the most sensitive data or services crucial for operations. In a social graph, the critical business assets are influential individuals or groups who can propagate information widely. A high value targets in a security graph 14 are nodes 16 that represent resources attackers are most likely to target because compromising them yields elevated privileges or access to sensitive information. For example, domain controllers in an information technology (IT) network or financial transaction systems in a banking environment.

In some implementations, the security graph 14 includes metadata 20 enriching the security graph 14 with additional context. One example of the metadata 20 includes permissions. Another example of the metadata 20 includes activity logs. Another example of the metadata 20 includes configurations. Another example of the metadata 20 includes policy details. Another example of the metadata 20 includes historical threat intelligence 26 (e.g., insights from past incidents, highlighting high-risk nodes or patterns).

In some implementations, the asset monitoring tool 102 is in communication with a machine learning model 110 and uses the machine learning model 110 in generating the security graph 14. The machine learning model 110 generates a sensitivity score 22 for the entities and uses the sensitivity score 22 in identifying nodes 16 in the security graph 14 as sensitive assets. In some implementations, the machine learning model 110 uses a scoring formula that integrates permissions for the entity, activity patterns of the entity, historical threat intelligence 26, and any known anomalies for the entity in generating the sensitivity score 22 for the node 16. The sensitivity score 22 reflects a criticality and risk exposure of an entity represented by the node 16. In some implementations, the sensitivity score 22 is predetermined for the entity. For example, the sensitivity score 22 for an entity with all account passwords is predetermined. In some implementations, the machine learning model 110 continues to update the sensitivity score 22 as a cloud environment evolves and changes. For example, as a number of users changes for an entity or access privileges changes for an entity, the sensitivity score 22 is modified reflecting the changes. The machine learning model 110 dynamically assigns the sensitivity score 22 to the node 16 based on real-time monitoring of the cloud environment. In some implementations, the metadata 20 includes the sensitivity score 22.

In some implementations, a list of sensitive assets 24 is generated with the entities of the nodes 16 based on the sensitivity score 22. For example, if the sensitivity score 22 for the node 16 is above a threshold (e.g., 85%), the entity is added to the list of sensitive assets 24. Another example includes if the sensitivity score 22 for the node 16 is below a threshold (e.g., 40%), the entity is removed from the list of sensitive assets 24. Entities may be added or removed from the list of sensitive assets 24 as the sensitivity score 22 changes. The list of sensitive assets 24 identifies the resources that reflect a risk exposure for cybersecurity threats. In some implementations, the list of sensitive assets 24 identifies the resources in a cloud environment that reflect a risk of exposure for cybersecurity threats. Creating the list of sensitive assets 24 reduces an amount of resources continuously monitored for anomalies 12 in a cloud environment.

In some implementations, the asset monitoring tool 102 propagates the sensitivity score 22 using the relationships identified in the edges 18 of the security graph 14. An example of a direct relationship identified by the edges 18 in the security graph 14 includes a service principal with a mail. read for the tenant is flagged as sensitive (e.g., using the sensitivity score 22), and all associated key vaults and databases (e.g., the nodes 16 in the security graph 14 directly connected to the node of the service principal with an edge 18) the service principal interacts with are marked for monitoring and added to the list of sensitive assets 24.

The asset monitoring tool 102 propagates the sensitivity score 22 beyond direct relationships accounting for transitive dependencies and indirect risks. Transitive propagation propagates sensitivity further than direct relationships. For example, a service principal with tenant-wide permissions receives a sensitivity score 22 above the threshold and is marked as a sensitive asset. The asset monitoring tool 102 propagates sensitivity to the dependent entities 36 (e.g., all associated key vaults and downstream resources) connected by edges 18 to the node 16 in the security graph 14 representing the service principal. For example, the asset monitoring tool 102 adds the dependent entities 36 (e.g., all associated key vaults and downstream resources) to the list of sensitive assets 24. A dependent entity relies on another entity in the security graph 14.

The asset monitoring tool 102 traverses the security graph 14 identifying direct relationships and transitive dependencies. In some implementations, the asset monitoring tool 102 regularly scans the security graph 14 with threat actor risks and text transfer protocols (TTPs) dynamically propagating sensitivity to relevant entities within the infrastructure. The asset monitoring tool 102 enables comprehensive risk assessment by propagating the sensitivity score 22 across the security graph 14 based on the dependencies identified through the edges 18 of the security graph 14 and adding the dependent entities 36 to the list of sensitive assets 24.

In some implementations, the asset monitoring tool 102 continuously monitors the list of sensitive assets 24 performing anomaly detection for the list of sensitive assets 24. In some implementations, the asset monitoring tool 102 uses the machine learning model 110 in performing the anomaly detection. The machine learning model 110 uses unsupervised learning techniques in generating a flag 28 of unusual behavior or configurations. In some implementations, the machine learning model generates the flag 28 identifying the entity as critical (e.g., requiring additional review or analysis).

In some implementations, the machine learning model 110 uses clustering to identify groups with similar configurations to known sensitive entities. The machine learning model 110 generates a flag 28 in response to the clustering. For example, a security group with MFA bypass linked to a high-risk service principal would receive a high score and the machine learning model 110 generates a flag 28 identifying the security group as requiring additional analysis or review and adds the security group to the list of sensitive assets 24. Another example includes the machine learning model 110 generates a flag 28 as critical for a security group with Conditional Access Administrator and adds the security group to the list of sensitive assets 24. Another example includes a security group is excluded from MFA or conditional access policies and the machine learning model 110 identifies and scores the group based on its permissions and membership. Frequent membership changes or external user additions raise a flag 28 by the machine learning model 110 for additional review and adds the group to the list of sensitive assets 24. By flagging the resources as critical or requiring additional review, the machine learning model prioritizes groups with administrative roles or global permission for continuous monitoring by the asset monitoring tool 102.

In some implementations, the machine learning model 110 analyzes access patterns 30 for the entity represented by the node 16 and identifies any anomalies 12 in the access patterns 30 in response to detecting unusual behaviors or configurations in the access patterns 30. An access pattern defines how data is accessed. For example, an access pattern defines how users and systems access data. The machine learning model 110 analyzes past behavior of the entity (e.g., from historical security logs) and identifies an unusual behavior in the access patterns 30 in response to analyzing the past behavior. For example, a database accessed by a rarely used service principal triggers an anomaly 12 by the machine learning model 110 in response to the access occurring to the database. Another example includes high-frequency key vault access triggers an anomaly 12 by the machine learning model 110.

Another example includes an application granted tenant-wide or app-only permissions (e.g., directory.read.all) is flagged and resources the application interacts with, such as databases or key vaults, are marked for monitoring (e.g., included on the list of sensitive assets 24 with a flag 28). The machine learning model 110 identifies a new interaction with a high-value resource (e.g., an unexpected access pattern 30) and flags the new interaction for further investigation.

In some implementations, the machine learning model 110 analyzes a fingerprint generated for the entity and uses the fingerprint in identifying whether an anomaly 12 occurred in the access pattern 30. The fingerprint provides a unique cryptographic value generated by a hash function that represents an entity and events for the entity. The machine learning model 110 compares the fingerprint to past behavior of the entity and identifies an unexpected access pattern 30 identified in the fingerprint. In some implementations, the machine learning model 110 analyzes historical threat intelligence 26 (e.g., insights from past incidents, highlighting high-risk nodes or patterns) and uses the information from the historical threat intelligence 26 in identifying whether an anomaly 12 occurred in the fingerprint.

In some implementations, the machine learning model 110 is a generative AI model. Examples of the generative AI model include a Generative Pre-trained Transformer (GPT) model (e.g., GPT-3 or GPT-4), LlaMA, and GEMINI. In some implementations, the asset monitoring tool 102 uses a plurality of machine learning models 110 in communication with the asset monitoring tool 102 in generating the sensitivity score 22 and identifying anomalies 12 in the list of sensitive assets 24.

In some implementations, the asset monitoring tool 102 generates an alert 32 in response an anomaly 12 identified an entity 34. For example, the alert 32 includes the entity 34 with the anomaly 12 and any dependent entities 36 of the entity 34 identified using the security graph 14. For example, a service principal with high permissions accesses a key vault. The machine learning model 110 provides a flag 28 to the key vault and propagates sensitivity to secrets stored within. Anomalies 12 in access patterns 30 (e.g., sudden spikes in secret retrievals) triggers the alert 32 for the service principal and any dependent entities 36 of the service principal identified using the security graph 14.

In some implementations, the asset monitoring tool 102 sends the alert 32 to a device 106 in communication with the asset monitoring tool 102. For example, the asset monitoring tool 102 is in communication with a device 106 via a network. In some implementations, the asset monitoring tool 102 is on a cloud server remote from the device 106 accessed through the network. For example, the asset monitoring tool 102 is hosted on virtual machines in the cloud. The network may include one or multiple networks and may use one or more communication platforms and/or technologies suitable for transmitting data. The network may refer to any data link that enables transport of electronic data between devices of the environment 100. The network may refer to a hardwired network, a wireless network, or a combination of a hardwired network and a wireless network. In one or more implementations, the network includes the internet. The network may facilitate communication between the various computing devices. The server may include one or more computing devices (e.g., including processing units, data storage, etc.) organized in an architecture with various network interfaces for connecting to and providing data management and distribution across one or more client systems. While one device is illustrated, the asset monitoring tool 102 may be in communication with a plurality of devices.

A user 104 accesses the asset monitoring tool 102 using the device 106. The device 106 may be representative of one or multiple devices and may refer to various types of computing devices. For example, the device 106 may include a mobile device such as a mobile telephone, a smartphone, a personal digital assistant (PDA), a tablet, a laptop, or any other portable device. Additionally, or alternatively, the device 106 may include one or more non-mobile devices such as a desktop computer, server device, or other non-portable device. In some implementations, the device 106 may be communicatively coupled (e.g., wired or wirelessly) to a display 108 having a user interface thereon providing a display of system content.

In some implementations, the asset monitoring tool 102 is accessed through the network. For example, a server address configured to an end point of the asset monitoring tool 102 is provided to the device 106 that the user 104 may access using a browser on the device 106. Another example includes an application on the device 106 of the user 104 provides access to the asset monitoring tool 102.

In some implementations, the alert 32 with the anomaly 12 for the entity 34 and the dependent entities 36 is presented on the display 108. In some implementations, the alert 32 is automatically presented on the device 106 in response to the asset monitoring tool 102 detecting the anomaly 12. In some implementations, the user 104 sends a request 40 for an analysis of the assets 10 to the asset monitoring tool 102 and the alert 32 is presented in response to the request 40. In some implementations, the user 104 uses the information presented on the display 108 to identify cybersecurity risks and take actions 38 to prevent the cybersecurity risks. For example, the user 104 selects to focus on a specific entity 34 or dependent entity 34 in investigating the cybersecurity risk. Another example includes the user 104 selects to focus on specific events in investigating the cybersecurity risk. Another example includes the user 104 blocking access to a resource.

Once an anomaly 12 is detected, appropriate security mitigation action(s) 38 may be automatically taken by the asset monitoring tool 102, such as an action to alert users of the computing system under attack (e.g. by displaying an alert, summary or explanation pertaining to the anomaly), modify a setting or parameter of a computing system (e.g. a computer, or a network of computers), isolate (e.g., quarantine, disconnect, deactivate etc.) an entity (e.g. user, device, service, process, application etc.) within such a computer system, or modify an access privilege associated with such an entity. An anomaly detection may trigger a further analysis to determine whether related activity is malicious or benign.

The environment 100 streamlines the process of incident investigation or a proactive threat hunting by using the security graph 14 in automatically identifying, prioritizing, and monitoring sensitive assets for anomalies 12. The environment 100 allows the users 104 to quickly focus on the most relevant assets to the incident investigation or threat hunting by providing the detected anomaly 12, the entity 34 and the dependent entities 36. The environment adapts to evolving configurations and behaviors, delivering actionable insights, empowering security teams in preventing cybersecurity threats. The environment 100 enables real-time monitoring and post event analysis allowing security teams to proactively search for and mitigate cybersecurity threats before the cybersecurity threats can cause significant harm to a cloud environment.

In some implementations, one or more computing devices (e.g., servers and/or devices) are used to perform the processing of the environments 100. The one or more computing devices may include, but are not limited to, server devices, cloud virtual machines, personal computers, a mobile device, such as a mobile telephone, a smartphone, a PDA, a tablet, or a laptop, and/or a non-mobile device. The features and functionalities discussed herein in connection with the various systems may be implemented on one computing device or across multiple computing devices. For example, the asset monitoring tool 102 and the machine learning models 110 are implemented on a single computing device. Moreover, in some implementations, one or more subcomponents of the features and functionalities discussed herein may be processed on different server devices of the same or different cloud computing networks. For example, the asset monitoring tool 102 and the machine learning models 110 are implemented on different server devices.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

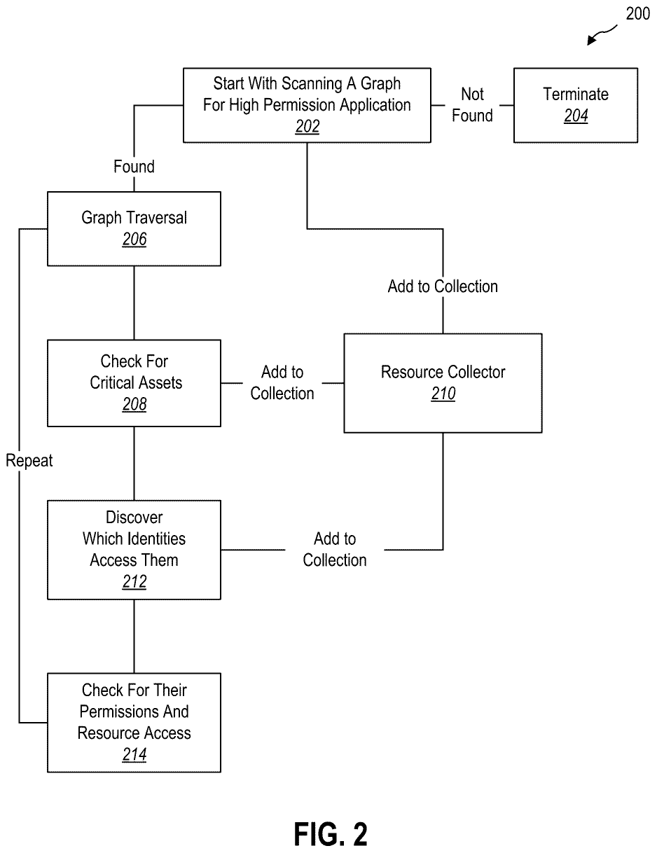

FIG. 2 illustrates an example method 200 for discovering sensitive assets (e.g., the list of sensitive assets 24 (FIG. 1)). In some implementations, the sensitive assets are in a cloud environment. In some implementations, the sensitive assets are on a device. The actions of the method 200 are discussed below in reference to FIG. 1. In some implementations, the actions of the method 200 are implemented by the asset monitoring tool 102. In some implementations, the actions of the method 200 are implemented by the machine learning model 110. In some implementations, the actions of the method 200 are implemented by a combination of the asset monitoring tool 102 and the machine learning model 110. In some implementations, the actions of the method 200 are implemented by a combination of the asset monitoring tool 102 and a plurality of machine learning models 110.

At 202, the method 200 includes scanning a security graph 14 for a sensitive asset. In some implementations, the sensitive asset is a high permission application. A high permission application is an application that has been granted broad powerful access to resources. A high permission application can read, write, delete or manage important data. If a high permission application falls into the wrong hands, serious damage can occur. In some implementations, the machine learning model 110 scans the security graph 14 for sensitive assets (e.g., high permission applications) using the metadata 20 of the security graph 14. The metadata 20 highlights or otherwise identifies nodes 16 in the security graph representing entities that are sensitive assets.

At 204, the method 200 ends in response to no sensitive assets identified. If the machine learning model 110 is unable to identify a node 16 in the security graph 14 identified as a sensitive asset (e.g., a high permission application), the method 200 ends.

At 206, the method 200 includes performing a graph traversal in response to identifying a sensitive asset. The machine learning model 110 performs a graph traversal of the security graph 14 starting from the node 16 in the security graph 14 identified as a sensitive asset (e.g., a high permission application).

At 208, the method 200 includes checking for sensitive assets. As the machine learning model 110 moves to a next node connected via an edge 18 in the security graph 14, the machine learning model 110 checks for sensitive assets. In some implementations, the sensitive assets are critical assets that impact operation (e.g., a resource that is mission critical to cloud operations). Examples of sensitive assets include key vault or a storage account. In some implementations, the machine learning model 110 uses the metadata 20 of the security graph 14 in identifying sensitive assets. For example, the metadata 20 includes the sensitivity score 22 of the node 16 and the machine learning model 110 uses the sensitivity score 22 in identifying the sensitive assets (e.g., the nodes 16 with a sensitivity score 22 over a threshold).

At 210, the method 200 includes adding the sensitive asset to a list of sensitive assets 24. The machine learning model 110 adds the sensitive asset to the list of sensitive assets 24. In some implementations, the list of sensitive assets 24 is stored in a datastore and updated as sensitive assets are identified during the graph traversal.

At 212, the method 200 includes discovering entities that access the sensitive assets 24. During the traversal of the security graph 14, the machine learning model 110 identifies dependent entities 36 of the sensitive assets by traversing the edges 18 of the security graph 14 to a next node 16 in communication with the sensitive assets 24. The machine learning model 110 adds the dependent entities 36 to the list of sensitive assets 24.

At 214, the method 200 includes checking for permissions and resource accesses. During the traversal of the security graph 14, the machine learning model 110 checks the permissions and resources access of the nodes 16. In some implementations, a flag 28 is added to the list of sensitive access in response to checking the permissions and resources access for further monitoring. The method returns to 206 to continue the traversal of the security graph 14 until no high permission application is identified by the machine learning model 110.

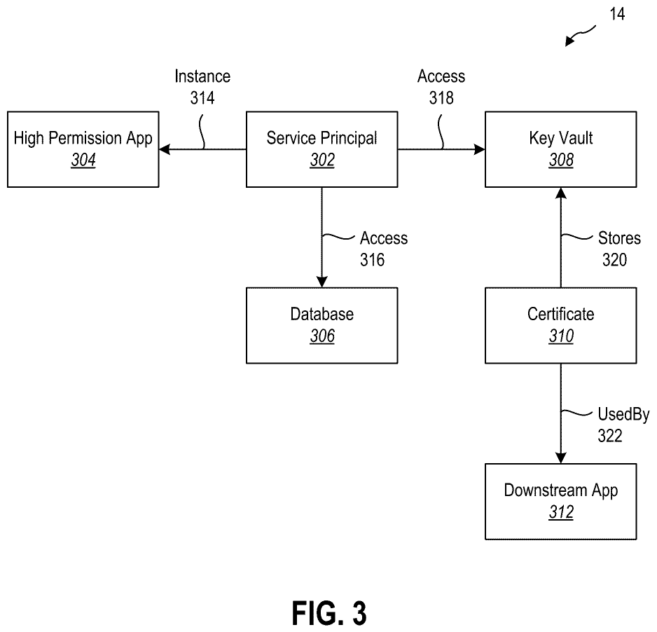

FIG. 3 illustrates an example security graph 14 generated by the asset monitoring tool 102 (FIG. 1). The security graph 14 includes a plurality of nodes 302, 304, 306, 308, 310, 312 (e.g., the nodes 16 (FIG. 1) connected by a plurality of edges 314, 316, 318, 320, 322 (e.g., the edges 18 (FIG. 1)). For example, the service principal of the node 302 is identified by the asset monitoring tool 102 as a sensitive asset and adds the service principal to the list of sensitive assets 24 (FIG. 1).

In some implementations, the asset monitoring tool 102 performs the method 200 (FIG. 2) and performs a graph traversal of the security graph 14 identifying the high permission application of the node 304, the database of the node 306, the key vault of the node 308 as having a direct relationship to the service principal (e.g., the edges 314, 316, and 318 directly connect to the node 302) and adds the high permission application, the database, and the key vault to the list of sensitive assets 24 as dependent entities 36 (FIG. 1) to the service principal. The asset monitoring tool 102 continues the graph traversal and identifies the certificate of the node 310 and the downstream application of the node 312 as an indirect relationship to the service principal (e.g., connected by the edge 320 to the node 308 (which is a direct relationship)) and adds the certificate and the downstream application to the list of sensitive assets 24 as dependent entities 36.

In some implementations, the machine learning model 110 performs the method 200 and performs a graph traversal of the security graph 14 identifying the high permission application of the node 304, the database of the node 306, the key vault of the node 308 as having a direct relationship to the service principal (e.g., the edges 314, 316, and 318 directly connect to the node 302) and adds the high permission application, the database, and the key vault to the list of sensitive assets 24 as dependent entities 36 to the service principal. The machine learning model 110 continues the graph traversal and identifies the certificate of the node 310 and the downstream application of the node 312 as an indirect relationship to the service principal (e.g., connected by the edge 320 to the node 308 (which is a direct relationship)) and adds the certificate and the downstream application to the list of sensitive assets 24 as dependent entities 36.

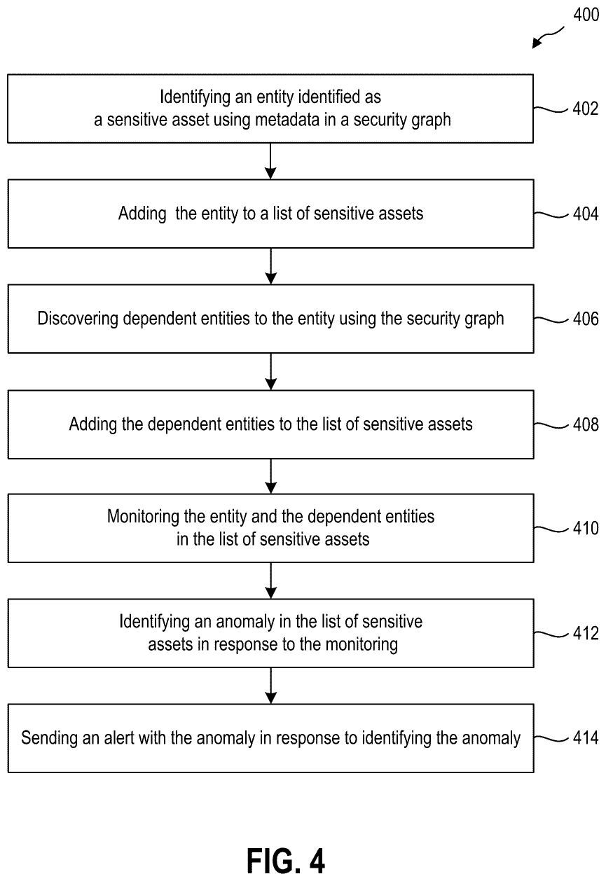

FIG. 4 illustrates an example method 400 for identifying cybersecurity risks. In some implementations, the method 400 identifies cybersecurity risks in a cloud environment. In some implementations, the method 400 identifies cybersecurity risks in a device. The actions of the method 400 are discussed below in reference to FIGS. 1-3. In some implementations, the actions of the method 400 are implemented by the asset monitoring tool 102. In some implementations, the actions of the method 400 are implemented by the machine learning model 110. In some implementations, the actions of the method 400 are implemented by a combination of the asset monitoring tool 102 and the machine learning model 110. In some implementations, the actions of the method 400 are implemented by a combination of the asset monitoring tool 102 and a plurality of machine learning models 110.

At 402, the method 400 includes identifying an entity identified as a sensitive asset using metadata in a security graph. In some implementations, the machine learning model 110 identifies an entity 34 in a cloud environment identified as a sensitive asset using metadata 20 in a security graph 14. The security graph 14 includes nodes 16 representing entities in a cloud environment and edges 18 representing relationships between the entities. A sensitive asset is a resource in a cloud environment that focuses on data sensitivity and exposure. A sensitive asset is any resource that holds, transmits, or protects valuable information. In some implementations, the metadata 20 includes a sensitivity score 22 calculated by the machine learning model 110 that identifies a cybersecurity risk of the entity 34. In some implementations, the metadata 20 includes historical threat intelligence 26 of past cybersecurity incidents in the cloud environment.

At 404, the method 400 includes adding the entity to a list of sensitive assets. In some implementations, the machine learning model 110 adds the entity 34 to a list of sensitive assets 24. In some implementations, the list of sensitive assets 24 limits the resources in a cloud environment continuously monitored by the asset monitoring tool 102 to the entities 34 and the dependent entities 36 included in the list of sensitive assets 24. In some implementations, the machine learning model 110 continues to update the list of sensitive assets 24 in response to changing conditions in the cloud environment.

At 406, the method 400 includes discovering dependent entities to the entity using the security graph. In some implementations, the machine learning model 110 discovers dependent entities 36 to the entity 34 using the security graph 14. In some implementations, the machine learning model 110 discovers the dependent entities 36 using the edges 18 in the security graph 14 and identifying the nodes 16 in the security graph 14 connected to the entity 34 through the edges 18. In some implementations, the machine learning model 110 identifies similar groups in the security graph 14 to the entity 34 by performing clustering and generating a flag 28 for the entities of the similar groups as requiring additional monitoring. For example, similar groups include entities with features in common. In some implementations, the machine learning model 110 clusters entities into groups based on configurations. For example, entities with configuration characteristics in common are clustered together as similar entities. In some implementations, the machine learning model 110 clusters entities into groups based on relationships. For example, entities with relationships in common (e.g., have an edge 18 to a node 16) are clustered together into a group. The machine learning model 110 adds the entities and the flag 28 to the list of sensitive assets 24.

At 408, the method 400 includes adding the dependent entities to the list of sensitive assets. In some implementations, the machine learning model 110 adds the dependent entities 36 to the list of sensitive assets 24.

At 410, the method 400 includes monitoring the entity and the dependent entities in the list of sensitive assets. In some implementations, the machine learning model 110 monitors the entity 34 and the dependent entities 36 in the list of sensitive assets 24. In some implementations, the machine learning model 110 monitors the access patterns 30 of the entity 34 and the dependent entities 36 in the list of sensitive assets 24.

At 412, the method 400 includes identifying an anomaly in the list of sensitive assets in response to the monitoring. In some implementations, the machine learning model 110 identifies an anomaly 12 in the list of sensitive assets 24. In some implementations, the machine learning model 110 identifies an anomaly 12 in the access patterns 30 of the entity 34 in the list of sensitive assets 24. In some implementations, the machine learning model 110 identifies an anomaly 12 in the access patterns 30 in the dependent entities 36 in the list of sensitive assets 24.

In some implementations, the machine learning model 110 identifies the anomaly 12 by analyzing learned past behaviors of the entity 34 and identifying an unexpected behavior in the access pattern 30 of the entity 34 as compared to the learned past behaviors of the entity 34.

In some implementations, the machine learning model 110 identifies the anomaly 12 by analyzing learned past behaviors of the dependent entities 36 and identifying an unexpected behavior in the access pattern 30 of the dependent entities 36 as compared to the learned past behaviors of the dependent entities 36.

In some implementations, the machine learning model 110 identifies the anomaly 12 by analyzing a fingerprint generated for the entity. The fingerprint provides a unique cryptographic value generated by a hash function representing the entity and events for the entity. The machine learning model 110 compares the fingerprint to a learned history of the entity 34 from past behaviors of the entity 34 and identifies the anomaly 12 in response to the fingerprint identifying an unexpected access pattern 30 for the entity 34.

At 414, the method 400 includes sending an alert with the anomaly in response to identifying the anomaly. In some implementations, the machine learning model 110 sends an alert 32 in response to identifying the anomaly. In some implementations, the asset monitoring tool 102 sends the alert 32 in response to identifying the anomaly. For example, the alert 32 identifies the anomaly 12 and the entity 34 with the anomaly 12 or a dependent entity 36 with the anomaly 12. In some implementations, the alert 32 is presented on a display 108 of a device 106.

In some implementations, the asset monitoring tool 102 automatically performs an action 38 preventing a cybersecurity risk in the cloud environment in response to the alert 32. In some implementations, the action 38 includes isolating the entity 34. In some implementations, the action 38 includes isolating a dependent entity 36. In some implementations, the action 38 includes preventing access to the entity 34. In some implementations, the action 38 includes blocking access to a dependent entity 36. In some implementations, the action 38 includes modifying access privileges. In some implementations, a user 104 performs the action 38 in response to the alert 32.

The method 400 dynamically discovers and prioritizes sensitive resources in a cloud environment for continuous monitoring by the asset monitoring tool 102. The method 400 automatically identify anomalies 12 and send alerts 32 in response to the identified anomalies 12. The method 400 enables security researchers and incident responders to stay ahead of evolving threats, ensuring adaptive security across cloud environments.

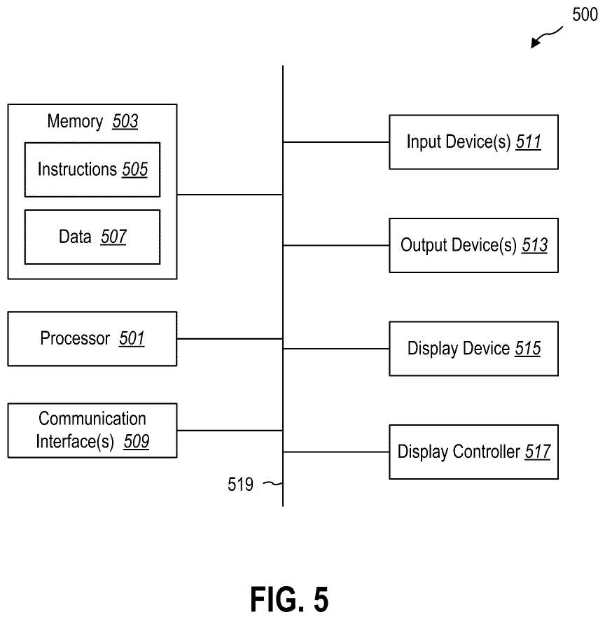

FIG. 5 illustrates components that may be included within a computer system 500. One or more computer systems 500 may be used to implement the various methods, devices, components, and/or systems described herein.

The computer system 500 includes a processor 501. The processor 501 may be a general-purpose single or multi-chip microprocessor (e.g., an Advanced RISC (Reduced Instruction Set Computer) Machine (ARM)), a special purpose microprocessor (e.g., a digital signal processor (DSP)), a graphics processing unit (GPU), a microcontroller, a programmable gate array, etc. The processor 501 may be referred to as a central processing unit (CPU). Although just a single processor 501 is shown in the computer system 500 of FIG. 5, in an alternative configuration, a combination of processors (e.g., an ARM and DSP) could be used.

The computer system 500 also includes memory 503 in electronic communication with the processor 501. The memory 503 may be any electronic component capable of storing electronic information. For example, the memory 503 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 505 and data 507 may be stored in the memory 503. The instructions 505 may be executable by the processor 501 to implement some or all of the functionality disclosed herein. Executing the instructions 505 may involve the use of the data 507 that is stored in the memory 503. Any of the various examples of modules and components described herein may be implemented, partially or wholly, as instructions 505 stored in memory 503 and executed by the processor 501. Any of the various examples of data described herein may be among the data 507 that is stored in memory 503 and used during execution of the instructions 505 by the processor 501.

A computer system 500 may also include one or more communication interfaces 509 for communicating with other electronic devices. The communication interface(s) 509 may be based on wired communication technology, wireless communication technology, or both. Some examples of communication interfaces 509 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 500 may also include one or more input devices 511 and one or more output devices 513. Some examples of input devices 511 include a keyboard, mouse, microphone, remote control device, button, joystick, trackball, touchpad, and lightpen. Some examples of output devices 513 include a speaker and a printer. One specific type of output device that is typically included in a computer system 500 is a display device 515. Display devices 515 used with embodiments disclosed herein may utilize any suitable image projection technology, such as liquid crystal display (LCD), light-emitting diode (LED), gas plasma, electroluminescence, or the like. A display controller 517 may also be provided, for converting data 507 stored in the memory 503 into text, graphics, and/or moving images (as appropriate) shown on the display device 515.

The various components of the computer system 500 may be coupled together by one or more buses, which may include a power bus, a control signal bus, a status signal bus, a data bus, etc. For the sake of clarity, the various buses are illustrated in FIG. 5 as a bus system 519.

In some implementations, the various components of the computer system 500 are implemented as one device. For example, the various components of the computer system 500 are implemented in a mobile phone or tablet. Another example includes the various components of the computer system 500 implemented in a personal computer. Another example includes the various components of the computer system 500 implemented in the cloud. Another example includes the various components of the computer system 500 implemented on an edge device.

As illustrated in the foregoing discussion, the present disclosure utilizes a variety of terms to describe features and advantages of the systems and methods. Additional detail is now provided regarding the meaning of such terms. For example, as used herein, a “machine learning model” refers to a computer algorithm or model (e.g., a classification model, a clustering model, a regression model, a language model, an object detection model, a probabilistic graphical model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

1. A method comprising:
traversing, using a machine learning model, a security graph with nodes representing entities in a cloud environment and edges representing relationships between the entities;
identifying, using the machine learning model, an entity identified as a sensitive asset using metadata in the security graph;
adding the entity to a list of sensitive assets;
discovering, by the machine learning model, dependent entities to the entity using the edges in the security graph;
adding the dependent entities to the list of sensitive assets;
monitoring, by the machine learning model, access patterns of the entity and the dependent entities in the list of sensitive assets;
identifying, by the machine learning model, an anomaly in the access patterns; and
sending an alert in response to identifying the anomaly.

2. The method of claim 1, further comprising:
presenting the alert on a display of a device, wherein the alert identifies the anomaly and the entity with the anomaly or a dependent entity with the anomaly.

3. The method of claim 1, further comprising:
performing an action preventing a cybersecurity risk in the cloud environment in response to the alert.

4. The method of claim 3, wherein the action includes isolating the entity, isolating a dependent entity, preventing access to the entity, blocking access to a dependent entity, or modifying access privileges.

5. The method of claim 1, wherein the metadata includes a sensitivity score calculated by the machine learning model that identifies a cybersecurity risk of the entity.

6. The method of claim 1, wherein the metadata includes historical threat intelligence of past cybersecurity incidents in the cloud environment.

7. The method of claim 1, wherein identifying the anomaly in the access patterns further includes:
analyzing, by the machine learning model, past behaviors of the entity; and
identifying, by the machine learning model, an unexpected behavior in the access pattern of the entity as compared to the past behaviors of the entity.

8. The method of claim 1, wherein identifying the anomaly in the access pattern further includes:
analyzing, by the machine learning model, past behaviors of the dependent entities; and
identifying, by the machine learning model, an unexpected behavior in the access pattern of the dependent entities as compared to the past behaviors of the dependent entities.

9. The method of claim 1, wherein identifying the anomaly in the access pattern further includes:
analyzing, by the machine learning model, a fingerprint generated for the entity, wherein the fingerprint provides a unique cryptographic value generated by a hash function representing the entity and events for the entity;
comparing, by the machine learning model, the fingerprint to a learned history of the entity from past behaviors of the entity; and
identifying, by the machine learning model, the anomaly in response to the fingerprint identifying an unexpected access pattern for the entity.

10. A device comprising:
a memory to store data and instructions; and
a processor operable to communicate with the memory, wherein the processor is operable to:
identify, using a machine learning model, an entity identified as a sensitive asset using metadata in a security graph with nodes representing entities and edges representing relationships between the entities;
add the entity to a list of sensitive assets;
discover, using the machine learning model, dependent entities to the entity using the security graph;
add the dependent entities to the list of sensitive assets;
monitor, using the machine learning model, the entity and the dependent entities in the list of sensitive assets;
identify, using the machine learning model, an anomaly in the list of sensitive assets in response to the monitoring; and
send an alert with the anomaly in response to identifying the anomaly.

11. The device of claim 10, wherein the metadata includes a sensitivity score calculated by the machine learning model that identifies a cybersecurity risk of the entity.

12. The device of claim 10, wherein the metadata includes historical threat intelligence of past cybersecurity incidents.

13. The device of claim 10, wherein the machine learning model discovers the dependent entities by:
identifying similar groups in the security graph to the entity by performing clustering;
generating a flag for the entities of the similar groups indicating the entities require additional monitoring; and
adding the entities and the flag to the list of sensitive assets.

14. The device of claim 10, wherein the machine learning model discovers the dependent entities by using the edges in the security graph and identifying entities connected to the entity through the edges.

15. The device of claim 10, wherein the machine learning model identifies the anomaly in the list of sensitive assets by:
analyzing, by the machine learning model, learned past behaviors of the entity included in the list of sensitive assets; and
identifying, by the machine learning model, an unexpected behavior in an access pattern of the entity as compared to the learned past behaviors of the entity.

16. The device of claim 10, wherein the machine learning model identifies the anomaly in the list of sensitive assets by:
analyzing, by the machine learning model, learned past behaviors of the dependent entities included in the list of sensitive assets; and
identifying, by the machine learning model, an unexpected behavior in an access pattern in a dependent entity as compared to the learned past behaviors of the dependent entities.

17. The device of claim 10, wherein the machine learning model identifies the anomaly in the list of sensitive assets by:
analyzing, by the machine learning model, a fingerprint generated for the entity, wherein the fingerprint provides a unique cryptographic value generated by a hash function representing the entity and events for the entity;
comparing, by the machine learning model, the fingerprint to a learned history of the entity from past behaviors of the entity; and
identifying, by the machine learning model, the anomaly in response to the fingerprint identifying an unexpected access pattern for the entity.

18. The device of claim 10, further comprising:
performing an action in response to the alert.

19. The device of claim 18, wherein the action includes isolating the entity, isolating a dependent entity, preventing access to the entity, blocking access to a dependent entity, or modifying access privileges.

20. A computer-readable storage medium including instructions that, when executed by a processor, cause the processor to:
traverse, using a machine learning model, a security graph with nodes representing entities in a cloud environment and edges representing relationships between the entities;
identify, using the machine learning model, an entity identified as a sensitive asset using metadata in the security graph;
add the entity to a list of sensitive assets;
discover, by the machine learning model, dependent entities to the entity using the edges in the security graph;
add the dependent entities to the list of sensitive assets;
monitor, by the machine learning model, access patterns of the entity and the dependent entities in the list of sensitive assets;
identify, by the machine learning model, an anomaly in the access patterns;
send an alert in response to identifying the anomaly; and
perform an action preventing a cybersecurity risk in the cloud environment in response to the alert.
